(19) United States
(12) Patent Application Publication
(10) Pub. No.: US 2004/0181866 A1
(43) Pub. Date: Sep. 23, 2004

(54) Stool for a movable vehicle

(76) Inventor: Shih Keng Yu, Taipei (TW)

Correspondence Address: TROXELL LAW OFFICE PLLC, 5205 LEESBURG PIKE, SUITE 1404, FALLS CHURCH, VA, 22041, US

(21) Appl. No.: 10/392,868

(22) Filed: Mar. 21, 2003

(51) Int. Cl. B60R 15/04

(52) U.S. Cl. 4/458

(57) ABSTRACT

A stool for a movable vehicle is one for seating, it forms a vibration absorbing means on the lower portion thereof contacting a floor, the vibration absorbing means is an integrally formed rubber block member, a structure made by stacking a plurality of layers of rubber tires one over another or a vibration absorbing zone formed by laying vibration absorbing springs. By providing the vibration absorbing means on the lower portion of the stool, vibration during moving of the movable vehicle against a user seating on the stool can be alleviated or eliminated.

### BACKGROUND OF THE INVENTION

1. Field of the Invention

The present invention is related to a stool for a movable vehicle, and especially to such a stool of which the lower portion contacting the floor is provided with a vibration absorbing means to absorb the vibration generated in moving of the vehicle.

2. Description of the Prior Art

In a long-range traffic vehicle such as a plane, a train or a bus, there are normally toilets provided for passengers in the long route. It is believed that we have a same experience that such toilets mostly are narrow and crowded; they can only afford temporary relaxing rather than long-term coziness. Toilet equipments in the spaces of such toilets mostly are made of metal or plastic in order that the vehicles will not be damaged during vibration; thereby, those toilet equipments used in families hardly appear in such movable vehicles.

Changing material can reduce damage of the toilet equipments used in such movable vehicles due to vibration; another factor of usage is neglected though. By space limitation, go to stool in such a movable vehicle is an unpleased thing, and the traffic vehicle may have vibration at any time, the toilet provided for getting relaxing now makes one very nervous, this surely is not the original intention in designing such space of such a facility.

In view of this, the present invention provides a stool for a movable vehicle in order to get rid of the above stated defects.

### SUMMARY OF THE INVENTION

The present invention provides a stool for a movable vehicle with a vibration absorbing means to absorb the vibration of the vehicle to make more coziness for users. The present invention is a stool specific for a movable vehicle; in a broad meaning, it can also directed to a stool for a household. It is characterized by that: the stool is one for seating, the lower portion of which contacting the floor forms a vibration absorbing means. Literally, the vibration absorbing means is a structure to absorb the vibration, it is an integrally formed structure made such as of hard rubber; it can also be in the form constructed from a structure with flexible stacked circling layers; alternatively, it can be a vibration absorbing zone formed by laying elastic members such as springs. The vibration absorbing means is provided on the lower portion of the stool and located around a drainage passageway, the drainage passageway is directly connected to and extended from the stool to lead to a drainage pipe under the floor; while the bottom of the stool generally forms a sealing surface, the stool is fixed on the floor by a sticking or fixing mode to prevent any leakage possibly induced. And more, if the vibration absorbing means is not integrally formed, by virtue that the drainage passageway of the stool is extended into the drainage pipe under the floor to a predetermined depth, vibrating of the vibration absorbing means will not make releasing of the drainage passageway from the drainage pipe to thereby ensure no leakage from the vibration absorbing means.

The present invention provides the vibration absorbing means on the lower portion of the stool, in order that the vibration induced when the traffic vehicle having the stool is moved can be effectively reduced or even eliminated to make a user going to stool feel cozier. The present invention has never seen in prior arts nor used in the same field; it is a brand-new invention.

The present invention will be apparent after reading the detailed description of the preferred embodiment thereof in reference to the accompanying drawings.

### BRIEF DESCRIPTION OF THE DRAWINGS

FIG. 1 is a front view of the stool of the present invention;

FIG. 2 is a sectional view taken from FIG. 1;

FIG. 3 is a sectional schematic view showing the structure of another embodiment of the present invention;

FIG. 4 is a sectional schematic view showing the structure of a further embodiment of the present invention.

### DETAILED DESCRIPTION OF THE PREFERRED EMBODIMENT

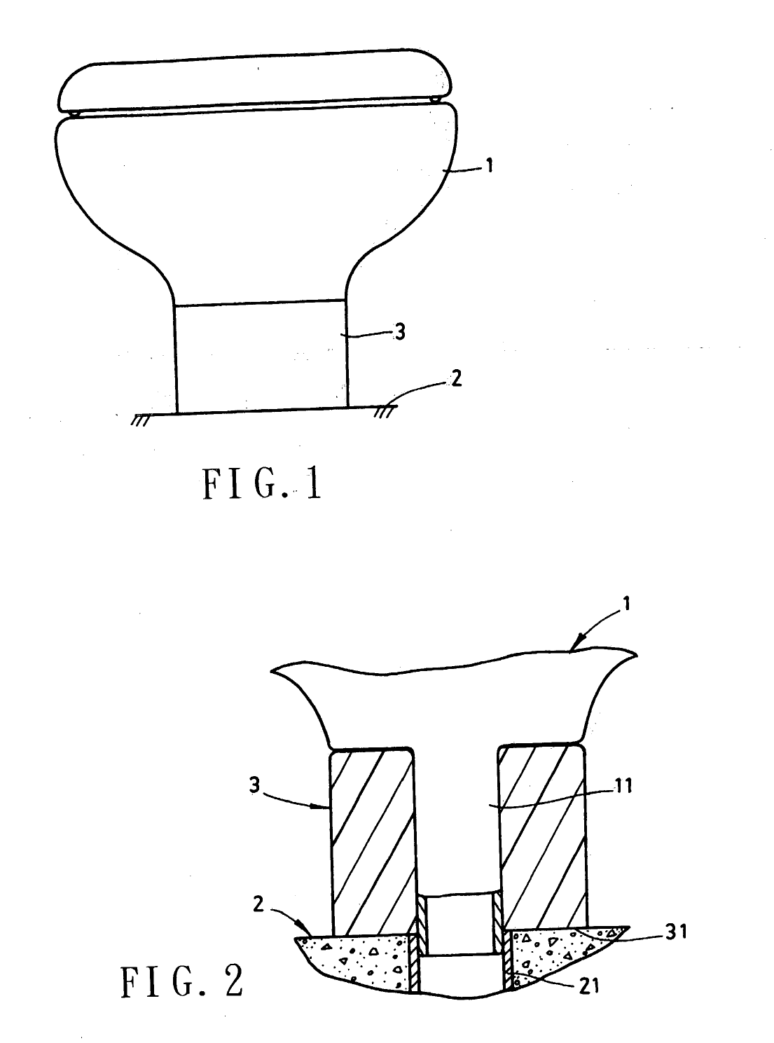

Referring firstly to FIGS. 1 and 2 showing an embodiment of a stool of the present invention used in a movable vehicle, wherein the stool 1 is provided on the lower portion thereof contacting a floor 2 with a vibration absorbing means 3; the vibration absorbing means 3 envelopes a drainage passageway 11 of the stool 1, the drainage passageway 11 is extended directly into a drainage pipe 21 under the floor 2 to a predetermined depth.

As shown in FIG. 2, the vibration absorbing means 3 of the present invention is integrally formed and made of vibration absorbing material such as hard rubber; the bottom 31 of the stool 1 generally has a sealing function to prevent leakage of the drainage passageway 11. The bottom 31 is fixed on the floor 2 by a sticking or fixing mode generally.

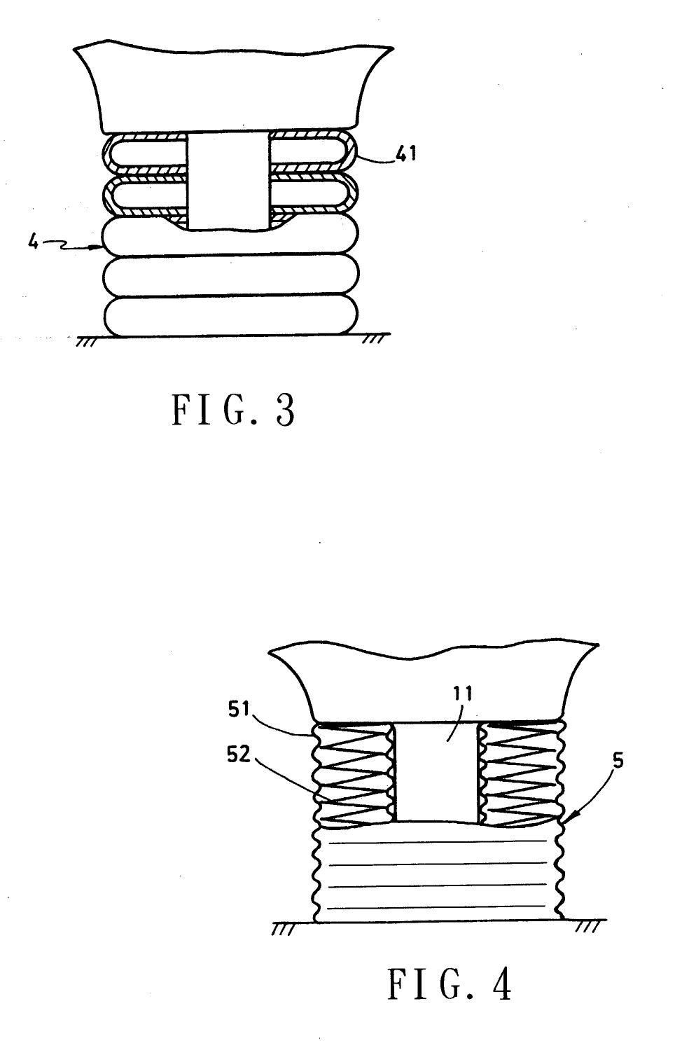

Referring to FIG. 3 depicting another vibration absorbing means 4 which can be a structure made by stacking a plurality of layers of vibration absorbing materials, it can be formed from a plurality of rubber tires 41 stacking one over another, the rubber tires 41 can be mutually stuck or can be independent but stacked, such rubber tires 41 can allow some transverse waving in addition to allowing vertical up and down vibrating.

As shown in FIG. 4 depicting another vibration absorbing means 5, in which it is provided around the drainage passageway 11 thereof with a flexible barrel 51 that is provided therein with a spring 52 or other means capable of absorbing the up and down vibration and allowing transverse waving; the spring 52 can attain a better vibration absorbing effect by increasing or reducing the pitches and number thereof.

The present invention thereby has the following advantages:

1. The vibration absorbing means provided in the present invention is made from elastic materials, so that it can reduce damage of the stool used in a movable vehicle due to vibration induced by shaking of the vehicle.

2. The vibration absorbing means of the present invention is made from elastic materials capable of absorbing vibration; thereby, discomfort such as aching and benumbed feeling of legs by overlong seating on the stool of a user can be alleviated.

Accordingly, the present invention can surely achieve its expected objects to provide a stool for a movable vehicle; it has the value of practicability. Having thus described my invention.

What I claim as new and desire to be secured by Letters Patent of the United States are:

1. A stool for a movable vehicle, said stool is one for seating, comprises: a vibration absorbing means on the lower portion thereof contacting a floor, said vibration absorbing means is an integrally formed structure; and the body of said stool having a drainage passageway extended from said stool and enveloped in said vibration absorbing means.

2. The stool for a movable vehicle as in claim 1, wherein said vibration absorbing means is integrally formed of hard rubber.

3. The stool for a movable vehicle as in claim 1, wherein said vibration absorbing means is a structure made by stacking a plurality of layers of rubber tires one over another.

4. The stool for a movable vehicle as in claim 1, wherein said vibration absorbing means is a flexible barrel that is provided therein with an elastic element.

5. The stool for a movable vehicle as in claim 4, wherein said elastic element is a spring.

6. The stool for a movable vehicle as in claim 1, wherein the contact area of said vibration absorbing means with said floor forms a sealing surface.

7. The stool for a movable vehicle as in claim 2, wherein the contact area of said vibration absorbing means with said floor forms a sealing surface.

8. The stool for a movable vehicle as in claim 3, wherein the contact area of said vibration absorbing means with said floor forms a sealing surface.

9. The stool for a movable vehicle as in claim 4, wherein the contact area of said vibration absorbing means with said floor forms a sealing surface.

10. The stool for a movable vehicle as in claim 1, wherein said drainage passageway is extended into a drainage pipe under said floor to a predetermined depth.
